(19) United States
(12) Patent Application Publication
(10) Pub. No.: US 2015/0339119 A1
(43) Pub. Date: Nov. 26, 2015

(54) System and Method Thereof for Creating Dynamically Attachable and Detachable Binary Files

(71) Applicant: Huawei Technologies Co., Ltd., Shenzhen (CN)

(72) Inventors: Irfan Ur Rehman, Bangalore (IN); Nair Sanil Kumar Divakaran, Bangalore (IN)

(21) Appl. No.: 14/721,541

(22) Filed: May 26, 2015

Related U.S. Application Data
(63) Continuation of application No. PCT/CN2014/089761, filed on Oct. 29, 2014.

(30) Foreign Application Priority Data
May 21, 2014 (IN) 2531/CHE/2014

(51) Int. Cl. G06F 9/44; G06F 9/45

(52) U.S. Cl. CPC G06F 8/70; G06F 8/41; G06F 8/427

(57) ABSTRACT

A technique for creating dynamically attachable and detachable binary files is provided. The invention provides an efficient mechanism to manage the existing code bases with respect to the additional code needed for a particular feature as a single code base. It also provides a mechanism for designers to plan for such features even before the code is conceptualized. The system parses the code having a dynamic feature manager (DFM) tag to produce a base code wherein the DFM tag encloses a feature. The multiple code sets based on the DFM tags are created. A feature change table storing the information about a changed feature compared to the feature from the code sets is generated and stored in the system. The code sets are then compiled to generate binaries. The difference between each of the binaries, using the feature change tables is determined and stored which is used for creating differential binary file(s).

### CROSS-REFERENCE TO RELATED APPLICATIONS

This application is a continuation of International Application No. PCT/CN2014/089761, filed on Oct. 29, 2014, which claims priority to India Patent Application No. IN2531/CHE/2014, filed on May 21, 2014, both of which are hereby incorporated by reference in their entireties.

### TECHNICAL FIELD

The present application generally relates to a system and method for creating binary files, and more particularly, to a system and method for creating dynamically attachable and detachable binary files.

### BACKGROUND

Traditionally a process of software development follows a very strict lifecycle. The process steps, in stated order have been, write code, compile, debug and fix issues, release and deploy. Once the software binary or a binary file has been deployed, it is extremely difficult to add or remove features to or from the running binary, without restarting. Even if restarted, it is a huge overhead if the state of the software has to be restored to the original state.

There have been some solutions to work around this limitation but each of them has their own shortcomings. The software developed may have modules for example, the modules storing a log level information, a debug information, and the like, which are designed to provide different functionality based on how they are compiled or configured. The behavior of these modules/files can be controlled during run time using some flags or configuration values, but the software code will have to be built with the whole binary. The shared library or a dynamically loaded library can also be used to manage such a feature, but the code to interface with the library and management of the same should be present within the originally written code.

There are various solutions provided in the prior-art wherein the debug and log level management can be configured during compile time using preprocessor macros, or during run time only if the same has been part of the original design and code. The modules can also be made as libraries which can be dynamically loaded, but again the design and coding of the same has to be done from the start and additional code for loading and interfacing with the correct library has to be in place in the original binary. Also, the applications are traditionally designed to have various log levels, trace prints, maintenance log options. The same should be part of the application code, and thus the compiled object code should be part of the binary or the library. An application live patching may be used to add additional piece of code, but these patches need to manage the original code and newly added code separately, ideally as patches or different files. Further, the patching is mainly advantageous for defect fixes or small upgrades only.

Another solution available for managing modules or the features with slightly different functionality is by using preprocessor macros at the compile time. Using preprocessor macros will strip out the alternate flow code in the resulting binary and there later would be no way to bring the same back, unless compiling the binary again. Also, the feature logic can be enabled or disabled, using some configurations during run time, but this is only possible by selecting an alternate code flow or path, and can only be done if the same is part of the original design, then code and subsequently the compiled object code.

In one solution, the modules can also be made as libraries which can be dynamically loaded, but again the design of the software with respect to the libraries should be done from the start and the supporting code to interface with the libraries has to be present in the software.

Apart from the above mentioned limitations, there are various other constraints that are imposed by the existing prior-art solutions. A few of them are listed below.

1. Development with add-on features or the features that may not be used by the release binary during deployment every time does not support single flow development.

2. In case of single flow code development where live patching can be used, the patch or a different file needs to be maintained and tracked, separately. Single source base is not supported well in such cases.

3. The quality and efficiency of development is hampered because of the above stated limitations and constraints.

4. Furthermore, in case of the higher application size, a maintenance need for the same is very high and also the size of application makes it difficult to make considerable changes in the binaries.

While the techniques for avoiding the above mentioned limitations and constraints are growing, there still exists a need to provide an efficient technical solution to overcome the above stated limitations and constraints. Accordingly, what would be desirable, but has not yet been provided, is a technique for creating dynamically attachable and detachable differential binary files, that provides an effective solution by reducing the time and cost of up gradation of any feature available in the existing binary files.

### SUMMARY

This summary is provided to introduce concepts related to a system and method thereof for creating executable binary files with reduced overheads, less up gradation time for the existing binary files and the concepts are further described below in the detailed description. This summary is not intended to identify essential features of the claimed application nor is it intended for use in determining or limiting the scope of the claimed application.

The above-described problems are addressed and a technical solution is achieved in the present invention by providing an optimized method of and system for creating dynamically attachable and detachable differential binary files, that provides an effective solution by reducing the time and cost of up-gradation of any feature available or desired to be newly added in the existing and currently executing binary file.

It is therefore a primary object of the present invention to provide a system and method for creating dynamically attachable and detachable differential binary files with reduced overheads and reduced time and cost of up gradation of any feature available in the existing and currently executing binary file or adding a new feature altogether in the existing and currently executing binary file.

It is another object of the present invention to support single flow development, base features and add on features, which can be segregated within the same code base.

It is another object of the present invention to avoid the need to maintain updates as patches, or differential code files, and continuous development on the same code base is made possible.

It is yet another object of the present invention that, the quality and efficiency of development of the software is improved using the proposed invention by reducing the time and cost of up gradation of any feature available or adding altogether a new feature in the existing binary files.

It is still another object of the present invention that, a footprint optimization, only necessary and required section of the binary code can be used on the targets run time environment. The add-on features can be brought in only when needed as differential binaries.

Accordingly, in one embodiment of the present invention, a computer system having a non-transitory computer-readable medium including computer program logic encoded thereon that, when executed on the system provides a mechanism for creating and managing at least one executable differential binary file is disclosed. The system performs the operation of parsing at least one computer program source code having at least one dynamic feature manager (DFM) tag. Based on the DFM tags, the system performs the operation of creating a plurality of code sets based on the DFM tags. The code sets comprises of a first code set having the base code, wherein the base code is the at least one computer program source code without any DFM tag, and at least one second code set having the base code and the feature, wherein the feature is a set of code. The system then performs the operation of generating a plurality of feature change tables, wherein the feature change tables store the information about a changed feature compared to the feature from the code sets. The system further performs the operation of stripping the DFM tag from the computer program source code to produce a base code, wherein the DFM tag is used to indicate that the feature is enclosed from the at least one computer program source code. The system then performs the operation of compiling the code sets for generating a plurality of binaries. The system then performs the operation of determining a difference between each of the binaries, using the feature change tables, thereby storing the difference determined. Finally, the system performs the operation of creating a differential binary file(s) based on the difference stored. In one implementation, the difference between each of the binaries may be determined based on the plurality of feature change tables created from source code, and for only those portions which have entry in the difference table already created by DFM while parsing code, thus optimizing and avoiding complete binary difference.

In another embodiment of the present invention, a process for creating and managing at least one executable differential binary file is disclosed. The process comprising the steps of automatically parsing at least one computer program source code having at least one DFM tag, creating a plurality of code sets based on the DFM tags, wherein the code sets comprises of a first code set having the base code, wherein the base code is the at least one computer program source code without any DFM tag, and at least one second code set having the base code and the feature, wherein the feature is a set of code; generating a plurality of feature change tables, wherein the feature change tables stores the information about a changed feature compared to the feature from the code sets; stripping the DFM tag from the computer program source code to produce a base code, wherein the DFM tag is used to indicate that the feature is enclosed from the at least one computer program source code; compiling the code sets for generating a plurality of binaries; determining a difference between each of the binaries, using the feature change tables, thereby storing the difference determined; creating a differential binary file(s) based on the difference stored. In one implementation, the difference between each of the binaries may be determined based on the plurality of feature change tables created from source code, and for only those portions which have entry in the difference table already created by DFM while parsing code, thus optimizing and avoiding complete binary difference.

In another embodiment of the present invention, a computer system for creating and managing at least one executable differential binary file is disclosed. The computer system comprises of a processor and a memory coupled to the processor. The processor is capable for executing a plurality of modules and a plurality of instructions present in the memory. The plurality of modules in the system comprises of a segregator module, a compiler wrapper module, and a loader module. The segregator module is configured to parse at least one computer program source code having at least one DFM tag. Further, the segregator module creates a plurality of code sets based on the DFM tags, wherein the code sets comprises of a first code set having the base code, wherein the base code is the at least one computer program source code without any DFM tag, and at least one second code set having the base code and the feature, wherein the feature is a set of code. The segregator module then generates a plurality of feature change tables, wherein the feature change tables stores the information about a changed feature compared to the feature from the code sets. Further, it strips the DFM tag from the computer program source code to produce a base code, wherein the DFM tag is used to indicate that the feature is enclosed from the at least one computer program source code. The compiler wrapper module is configured to compile the code sets for generating a plurality of binaries. The plurality of instructions in the memory is configured to determine a difference between each of the binaries, using the feature change tables, thereby storing the difference determined. Then a differential binary file(s) based on the difference stored is created by the system. In one implementation, the difference between each of the binaries may be determined based on the plurality of feature change tables created from source code, and for only those portions which have entry in the difference table already created by DFM while parsing code, thus optimizing and avoiding complete binary difference.

These and other features and advantages will become apparent from the following detailed description of illustrative embodiments thereof, which is to be read in connection with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

Corresponding reference characters indicate corresponding parts throughout the several views. The exemplification set out herein illustrates preferred embodiments of the invention, in one form, and such exemplification is not to be construed as limiting the scope of the invention in any manner.

FIG. 1 illustrates the computer system and a detailed working of the system creating and managing at least one executable differential binary file is shown, in accordance with an embodiment of the present application.

FIG. 2 illustrates a method creating and managing at least one executable differential binary file is shown, in accordance with an embodiment of the present application.

FIG. 3 illustrates a DFM's functionality, in accordance with an embodiment of the present application.

FIG. 4 illustrates a compilation, generation of binary files and updating the same is shown, in accordance with an embodiment of the present application.

FIG. 5A illustrates a standard Executable and Linkable Format (ELF) file contents is shown, in accordance with an embodiment of the present application.

FIG. 5B illustrates an exemplary differential binary content is shown, in accordance with an embodiment of the present application.

It is to be understood that the attached drawings are for purposes of illustrating the concepts of the invention and may not be to scale.

### DETAILED DESCRIPTION

In order to make the aforementioned objectives, technical solutions and advantages of the present application more comprehensible, embodiments are described below with accompanying figures.

The objects, advantages and other novel features of the present invention will be apparent to those skilled in the art from the following detailed description when read in conjunction with the appended claims and accompanying drawings.

Preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the application of the present invention unclear.

A system and method for creating and managing differential binary file(s) 220 is disclosed. Programming or coding language tags similar to preprocessor macros and labels common in C/C++ like programming languages are used for the creation of attachable and detachable binary files. The functional blocks of code, which are required to be made as attachable modules, may be placed between these tags. At least one wrapper on top of the popular compilers, which may understand the tags and generate differential binaries (in place of a single binary) based on the additional flags is proposed. It is understood that the compilers may be used from the already available and known compilers, for example “gcc” compiler.

Accordingly, the system and method for creating and managing differential binary file(s) 220 is disclosed. The executable differential binary file(s) 220 may be used as and when required by the programming or coding language. The differential binary file(s) 220 may be used by already prevalent application live patching or hot patching techniques available in the prior art. Further, the available application live patching techniques may be used by the proposed systems and methods to load and/or unload the generated differential binary file(s) 220 with respect to an existing or updated binary file in-memory at run time.

In one implementation, a computer system having a non-transitory computer-readable medium including computer program logic encoded thereon that, when executed on the system provides a mechanism for creating and managing at least one executable differential binary file 220 is disclosed. The system performs the operation of parsing at least one computer program source code having at least one DFM tag. Based on the DFM tags the system performs the operation of creating a plurality of code sets based on the DFM tags. The code sets comprises of a first code set having the base code, wherein the base code is the at least one computer program source code without any DFM tag, and at least one second code set having the base code and the feature, wherein the feature is a set of code. The system then performs the operation of generating a plurality of feature change tables 216, wherein the feature change tables 216 stores the information about a changed feature compared to the feature from the code sets. The system further performs the operation of stripping the DFM tag from the computer program source code to produce a base code, wherein the DFM tag is used to indicate that the feature is enclosed from the at least one computer program source code. The system then performs the operation of compiling the code sets for generating a plurality of binaries. The system then performs the operation of determining a difference between each of the binaries, using the feature change tables 216, thereby storing the difference determined. Finally, the system performs the operation of creating a differential binary file(s) 220 based on the difference stored. In one implementation, the difference between each of the binaries may be determined based on the plurality of feature change tables created from source code, and for only those portions which have entry in the difference table already created by DFM while parsing code, thus optimizing and avoiding complete binary difference. In one implementation, it is understood that the difference between each of the binaries may be determined because the code sets are incremental; hence the binaries will also have incremental features in them.

While the illustrative embodiments of the present invention are described below, it will be appreciated that the present invention may be practiced without the specified details, and that numerous implementation-specific decisions may be made to the invention described herein to achieve the developer's specific goals, such as compliance with system-related and business-related constraints, which will vary from one system to other systems such a development effort might be complex and time-consuming, it would nevertheless be a routine undertaking for those of ordinary skill in the art having the benefit of this disclosure. For example, selected aspects are shown in block diagram form, rather than in detail, in order to avoid obscuring or unduly limiting the present invention. Such descriptions and representations are used by those skilled in the art to describe and convey the substance of their work to others skilled in the art. The present invention will now be described with reference to the drawings described below.

While aspects of described system and method for dynamically creating and managing at least one executable differential binary file 220, may be implemented in any number of different computing systems, environments, and/or configurations, the embodiments are described in the context of the following exemplary system.

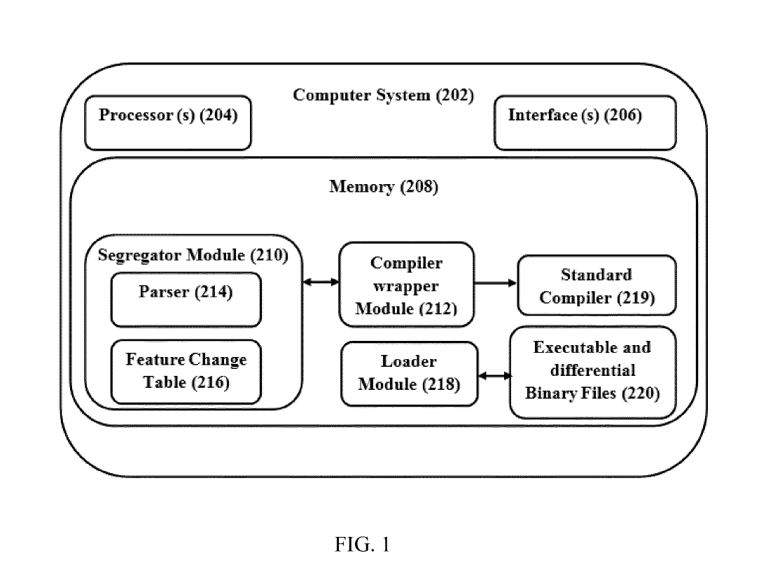

Referring now to FIG. 1, the computer system 202 and a detailed working of the computer system 202 for creating and managing at least one executable differential binary file 220 is illustrated in accordance with an embodiment of the present application. In one embodiment, the computer system 202 may include at least one processor 204, an input/output (I/O) interface 206, and a memory 208. The at least one processor 204 may be implemented as one or more microprocessors, microcomputers, microcontrollers, digital signal processors, central processing units, state machines, logic circuitries, and/or any devices that manipulate signals based on operational instructions. Among other capabilities, the at least one processor 204 is configured to fetch and execute computer-readable instructions stored in the memory 208.

The I/O interface 206 may include a variety of software and hardware interfaces, for example, a web interface, a graphical user interface, and the like. The I/O interface 206 may allow the computer system 202 to interact with a user directly or through the client devices. Further, the I/O interface 206 may enable the computer system 202 to communicate with other computing devices, such as web servers and external data servers (not shown). The I/O interface 206 can facilitate multiple communications within a wide variety of networks and protocol types, including wired networks, for example, local area network (LAN), cable, etc., and wireless networks, such as wireless local area network (WLAN), cellular, or satellite. The I/O interface 206 may include one or more ports for connecting a number of devices to one another or to another server. In one implementation, the computer system 202 provides an interface 206 to the user that may help in tagging and maintaining a programming code, and submitting the same for compilation. This computer system 202 may involve an editor and a graphical utility also which can be used by the developer, but is irrelevant with respect to the scope of this invention.

The memory 208 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 208 may include a plurality of modules and a plurality of instructions.

The plurality of modules includes routines, programs, objects, components, data structures, etc., which perform particular tasks or implement particular abstract data types. In one implementation, the modules may include a segregator module 210, a compiler wrapper module 212, a loader module 218, and a standard compiler 219. The memory may also include programs or coded instructions that supplement applications and functions of the computer system 202. The segregator module 210 may further include a parser 214 and a feature change table 216. Further, executable and differential binary files 220, hereinafter referred to as executable differential binary files 220 are generated during the overall processing in the computer system 202 and may also be stored in the memory 208 or may also be stored in the external source of storage.

It may be understood that the plurality of modules may generate data, amongst other things, the data generated may serves as a repository for storing data processed, received, and generated by one or more of the modules disclosed above. Further, the data generated as a result of the execution of one or more programs or coded instructions in the memory may also be stored in the data.

In one implementation, the memory 208 is coupled to the processor 204 for executing the plurality of modules and the plurality of instructions present in the memory 208. The segregator module 210 may be configured to parse at least one computer program source code having at least one DFM tag. The segregator module 210 further creates a plurality of code sets based on the DFM tags. The code sets may include a first code set having the base code, wherein the base code is the at least one computer program source code without any DFM tag. The code sets may also include at least one second code set having the base code and the feature, wherein the feature is a set of code. In one implementation, the DFM tag follows syntax as DFM_<the feature name>_start and DFM_<the feature name>_end to enclose a feature. The DFM tag may be added while writing the computer program source code or while adding or updating the new code to the computer program source code. The feature enclosed in DFM tags is selected from a group comprising of a function, a global variables and structures, a common macros, an inline function, a static variable, and a combination thereof. The DFM tag follows a rule wherein a corresponding ‘end’ DFM tag is matched with a ‘start’ DFM tag of each feature. The module 210 strips the DFM tag from the computer program source code to produce a base code, wherein the DFM tag is used to indicate that the feature is enclosed from the at least one computer program source code.

In one implementation, the segregator module 210 is further configured to check for a nesting of the DFM tag and creates a hierarchy tree of the computer program source code, wherein the hierarchy tree comprising a DFM unrelated tag arranged at a topmost level, and a child and/or sibling tag as the next level node in the hierarchy tree. DFM tags hereinafter referred to as tags.

The segregator module 210 then generates a plurality of feature change tables 216, wherein the feature change tables 216 stores the information about a changed feature compared to the feature from the code sets.

In one implementation, the segregator module 210 may be configured to parse the computer program source code having at least one tag to search for at least one tag usage in the computer program source code using at least one parser 214. The parser 214 may be stored in the memory 208 and may be accessed when the parsing of the at least one computer program source code is required. It is understood that the parser/s 214 used in the computer system 202 are already available parsers in the prior-art. The segregator module 210 may further check for a nesting of the at least one tag and creating a hierarchy tree of the computer program source code with the at least one tag. The nesting of the at least one tag may be used to create an overlay of at least one feature. Hence, the nesting of the tag may create multiple new binary files. The hierarchy tree created may include at least one unrelated tag arranged at the topmost level, and at least one child and/or sibling tag as the next level node in the hierarchy tree. The at least one unrelated tag is a tag that is not dependent on any other tag or the tag, and the at least one child and/or sibling tag is a tag that is dependent on any other tag or the tag. Based on the each node of the hierarchy tree at least one new binary file may be created. The feature change table 216 generated by the segregator module 201 may store the information about a changed feature compared to the feature from the code sets. The changed feature may be selected from a group comprising of functions, global variables, structures, common macros, inline functions, static variables, and/or a combination thereof, changed or newly introduced or updated per feature as compared to the feature from the code sets.

The compiler wrapper module 212 may be configured to compile the code sets for generating a plurality of binaries. The plurality of instructions available in the memory then determines a difference between each of the binaries, using the feature change tables 216, thereby storing the difference determined. The system then creates differential binary file(s) 220 based on the difference stored. In one implementation, the difference between each of the binaries may be determined based on the plurality of feature change tables created from source code, and for only those portions which have entry in the difference table already created by DFM while parsing code, thus optimizing and avoiding complete binary difference. In one implementation, it is understood that the difference between each of the binaries may be determined because the code sets are incremental; hence the binaries will also have incremental features in them.

The loader module 218 may be configured to manage the differential binary file(s) 220, wherein the differential binary file(s) 220 are managed by dynamically loading or unloading the differential binary file(s) 220 to the memory 208 and mapping the differential binary file(s) 220 to executing binary.

In one example, the at least one tag may be added while writing the computer program source code or while adding or updating a new code to the computer program source code. The nesting of the at least one tag may follow a rule wherein a corresponding ‘end’ tag is matched with a ‘start’ tag of each feature.

The memory 208 may also include the plurality of instructions. The instructions, when executed, generate the executable differential binary file 220 based on the difference between each of the binaries, using the feature change tables 216. The instructions may extract specific contents from the at least one new binary file created that causes the determined differences, wherein the specific contents comprises text and data related to the at least one feature of the at least one new binary file created. The specific contents may include a source code related to the at least one feature of the at least one new binary file created. The extracted specific contents may be compiled to build the at least one executable differential binary file 220. The at least one executable differential binary file 220 may be built from the compiled extracted specific content that may include linking the compiled extracted specific content to the at least one new binary file created, or to the new computer program source code generated after loading the at least one executable differential binary file 220 in it. In one implementation, the difference between each of the binaries may be determined based on the plurality of feature change tables created from source code, and for only those portions which have entry in the difference table already created by DFM while parsing code, thus optimizing and avoiding complete binary difference. In one implementation, it is understood that the difference between each of the binaries may be determined because the code sets are incremental; hence the binaries will also have incremental features in them.

The DFM system 202 may also include required support in terms of software that may be configured to execute the at least one computer program source code, and a binary file generated after loading the at least one executable differential binary file 220 in it.

It is well understood by the person skilled in the art that, the standard compiler 219 and the compiler wrapper module 212 may provide the functionality as a program which translates a high level language (HLL) code into a machine level language (MLL) code. The module 212 and standard compiler 219 may check all kinds of limits, ranges, errors and the like available in the software program provided. The compiler may work through the entire program and then translate the entire program into machine codes. If a compiler runs on a computer and produces the machine codes for the same computer then it is known as a self compiler or resident compiler. On the other hand, if a compiler runs on a computer and produces the machine codes for other computers then it is known as a cross compiler.

Also, it is well understood by the person skilled in the art that, the loader module 218 may provide functionality as a program that loads MLL code of a program into the system memory. The loader may be the part of an operating system that is responsible for loading programs. It may be one of the important stages in the process of starting a program, as it places programs into memory and prepares them for execution. The loading of the software program code involves reading the contents of executable file into memory. Once loading is complete, the operating system may start the program by passing control to the loaded program code. All operating systems that support program loading may have loaders. In many operating systems the loaders are permanently resident in memory.

In one implementation, the differential binary files may be managed run time by DFM using a binary hot patching, which is an established prior art. The proposed invention uses the standard method of introducing a jump instruction at the beginning of the function which has changed, to the new location where the changed text of the function is loaded.

The loading and execution of binary files may follow the operating system standard procedure. The differential binary however will need special treatment. The loader module 218, which may be implemented as an extension to the standard loader or an independent loader, may need to load the specified sections of the differential binary in memory and map the same into the address space of the already executing base binary. The loader module 218 may also maintain a small registry in memory, to keep track of the features loaded, at the given instance. In the most common implementation, the main task that loader module 218 does is locate the changed function's original text portion, and insert a ‘jmp’ instruction in place, to jump to the new address where the updated function text is loaded. In this way all older references to this function will first execute the call to the original function and then immediately be redirected to the new function text. An overhead of an additional function frame may however exist on the stack. For the change in data, the updated and added symbols will need to be replaced and added in the base binary data sections and handling, for initialized and non-initialized values will also be needed in implementation. The original type and scope of the replaced data symbol will be stored in the DFM registry to be used when the feature needs to be unloaded.

For unload, removing the inserted jump instruction from the original function footprint will suffice to revert the usage to the older function. The implementation of reverting the changes to data sections are more complicated. The data changes may, for example, be reverted back to their original values using the corresponding type and scope stored in the DFM registry.

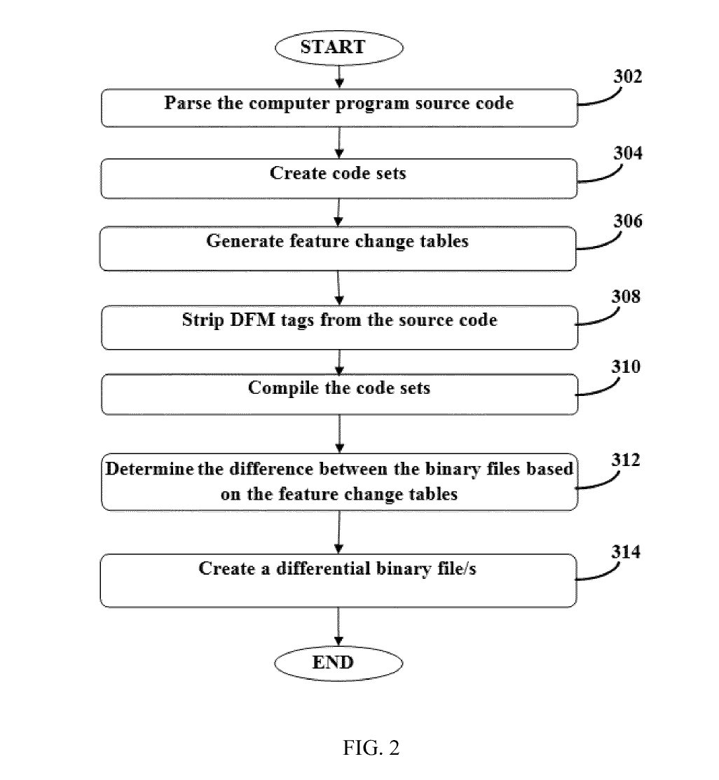

Referring now to FIG. 2, a method/ process for creating and managing at least one executable differential binary file 220 is shown, in accordance with an embodiment of the present application. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method/process is described is not intended to be construed as a limitation, and any number of the described method blocks can be combined in any order to implement the method or alternate methods. Additionally, individual blocks may be deleted from the method without departing from the spirit and scope of the application described herein. Furthermore, the method can be implemented in any suitable hardware, software, firmware, or combination thereof. However, for ease of explanation, in the embodiments described below, the method may be considered to be implemented in the above described computer system 202.

At block 302, the computer program source code may be received from the interface 206 provided by the computer system 202. The at least one computer program source code with the at least one tag is parsed using the segregator module 210. During the parsing, the at least one tag is searched for the at least one tag usage in the computer program source code. Further, the computer program source code is checked for a nesting of the at least one tag and thereafter a hierarchy tree of the computer program source code with the at least one tag is created. The hierarchy tree may include at least one unrelated tag that may be arranged at the topmost level and at least one child and/or sibling tag that may be arranged as the next level node in the hierarchy tree. The at least one unrelated tag is a tag that is not dependent on any other tag or the tag, and the at least one child and/or sibling tag is a tag that is dependent on any other tag or the tag. The nesting of the at least one tag follows a rule wherein an corresponding ‘end’ tag is matched with a ‘start’ tag of each feature.

At block 304, the plurality of code sets based on the DFM tags are produced. The code set may include a first code set having the base code, wherein the base code is the at least one computer program source code without any DFM tag, and at least one second code set having the base code and the feature, wherein the feature is a set of code.

At block 306, a plurality of feature change tables 216 are generated. The feature change tables 216 stores the information about a changed feature compared to the feature from the code sets. The feature is selected from a group comprising of a function, a global variables and structures, a common macros, an inline function, a static variable, and a combination thereof

At step 308, the DFM tag from the computer program source code is stripped to produce a base code. The DFM tag may enclose a feature from the at least one computer program source code. The at least one tag is added while writing the computer program source code or while adding or updating the new code to the computer program source code. The at least one computer program source code is compiled after stripping the at least one tag from the computer program source code. The computer program source code may be stripped using the inbuilt parsers as disclosed above.

At step 310, the code sets are compiled for generating a plurality of binaries.

At step 312, the difference between each of the binaries, using the feature change tables 216 is determined and the difference determined is stored.

At step 314, the differential binary file(s) 220 based on the difference stored are created.

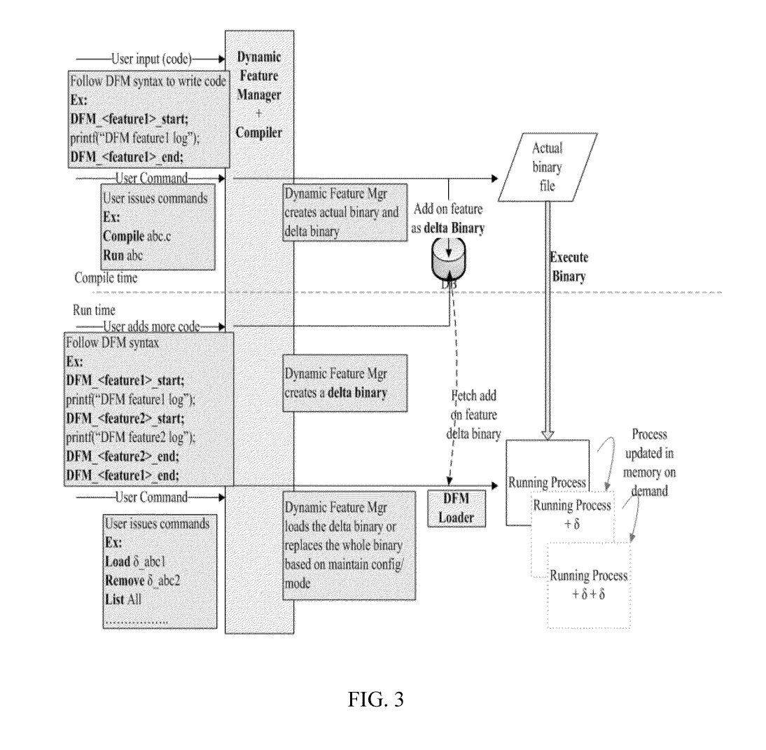

Referring now to FIG. 3, a DFM's functionality is shown, in accordance with an embodiment of the present application. In one implementation, the DFM may provide the utility and the framework for the proposed invention. The DFM may include mainly of the feature management utility as DFM itself, the DFM compile wrapper which is the interface for the developers and the users of DFM for compilation, a run time feature management utility as the loader or DFM loader, which helps the user to load and unload pluggable features or the executable binary files created at run time, the DFM segregator, which helps the DFM identify the differential functional blocks found in code based on the DFM tags.

The DFM may provide the interface 206 to the user and helps in tagging and maintaining the code, and submitting the same for compilation. This feature can involve an editor and a graphical utility also which can be used by the developer, but is irrelevant with respect to the scope of this invention.

The DFM compile wrapper which is the compiler module 212 may act as an intermediary between the developer and the compiler. It also would have hooks to the compilation stages, to provide compilation errors and warning pertaining to the restrictions implied by the DFM tags used in the code. It would also help in managing the statistical and difference information of the DFM tags with respect to the functional blocks in code.

The DFM loader which is the loader module 212 may be a utility to manage the delta features or the features of the new binary file created, at run time. It provides interfaces to the user to dynamically load and unload the delta functional blocks or executable binary files, into memory. It can use any of the prevalent application hot patching mechanisms, as listed in the references to the prior art, to load and unload the dynamic features in memory.

The DFM segregator which is the segregator module 210 will parse the DFM tags in code and create the categorical listing of changes observed in code with respect to each valid feature tag found. It will also create the staged code sets in different workspaces which will be used to generate binaries corresponding to each feature.

The proposed invention segregates the add-on functional blocks of code with the usage of DFM tags. It may involve defining the syntax and the additional construct for a given language. As an example to prove the implementation of the idea, the details using C language and the Gnu Compiler Collection as the compiler is given below.

The DFM tags may be used while writing the original code to segregate a particular feature, or adding code as a feature to the existing code base. The DFM tag needs to follow the syntax as DFM_<feature name>_start and DFM_<feature name>_end to enclose a functional block. There could be multiple functional blocks, pertaining to the same feature, spanning across the overall code base, until each of them is clearly enclosed within a ‘start’ and ‘end’ tag for that particular feature. It is also needed to ensure that the set of feature tags for the same feature spanning across the code base, do not introduce incoherency in the existing code or the code added.

As an example to represent the overlaying of features, we provide a snippet of original code and a small portion of add on code (which represents an additional feature) using the DFM tags:

Original code, simply taking an input and displaying the number:

#include <stdio.h>
#include <stdlib.h>
int main( )
{

long int Result=0

long Sum_dig=0;

printf(“\n Enter Number : ”);
scanf(\“%ld\”,&Num);

Result=Num;

printf(“\n the Result is:%ld ”,Result);
return(0);

}

If add sum is a feature.
We use DFM_SUM_start and DFM_SUM_end as tags:

#include <stdio.h>
#include <stdlib.h>

DFM_SUM_start
#include <ctype.h>
#include <math.h>
long int Sum_of_Digits(long int Number)

{

static long int sum=0;
if (Number==0)
{ return(sum);

}

else
{
sum=sum+Number%10+Sum_of_Digits(Number/10);
}
return(sum);

}

DFM_SUM_end
int main( )
{

long int Result=0

long Sum_dig=0;

printf(“\n Enter Number : ”);
scanf(\“%ld\”,&Num);

DFM_SUM_start

Sum_dig=Sum_of_Digits(Num);
Result=Sum_dig;

DFM_SUM_end

printf(“\n the Result is:%ld ”,result);
return(0);

}

The DFM manager will internally create workspaces with respect to each feature (or feature set), as the detail already included in the document further, while talking about base binary as Bb and add on features as f1, f2, etc.

This is the simplest example shown for only understanding of the overall process and shall not limit the scope of the invention, and when we use the term code set, it is a code base with no limit on files and folders and interdependencies.

The DFM tags may be nested to create an overlay of features and thus enable the DFM to create multiple delta binaries which can be loaded on top of each other, run time on demand. The nesting of DFM features should follow one simple rule, which is matching the corresponding feature ‘end’ tag for each feature ‘start’ tag encountered. As an example, a snippet of code representing multiple features nested, one within the other is given below:

Hence another feature named DEBUGPRINT is introduced on top of SUM.

The DFM_DEBUGPRINT_start and DFM_DEBUGPRINT_end are used as tags:

#include <stdio.h>
#include <stdlib.h>

DFM_SUM_start // sum feature

#include <ctype.h>
#include <math.h>

long int Sum_of_Digits(long int Number)
{

static long int sum=0;
if (Number==0)
{ return(sum);

}

else
{
sum=sum+Number%10+Sum_of_Digits(Number/10);
}
return(sum);

}

DFM_SUM_end
DFM_DEBUGPRINT_start // debugprint feature
#define DEBUGPRINT(msg) \

printf(“debug print from file - %s, and line -

%d, as - %s/n”,_FILE_,_LINE_, msg);
DFM_DEBUGPRINT_end
int main( )
{

long int Result=0

long Sum_dig=0;

printf(″\n Enter Number : ″);
scanf(\″%ld\″,&Num);

DFM_SUM_start

Sum_dig=Sum_of_Digits(Num);

DFM_DEBUGPRINT_start

DEBUGPRINT(“sum of digits introduced”);

DFM_DEBUGPRINT_end

Result=Sum_dig;

DFM_SUM_end

printf(″\n the Result is:%ld ″,result);
return(0);

}

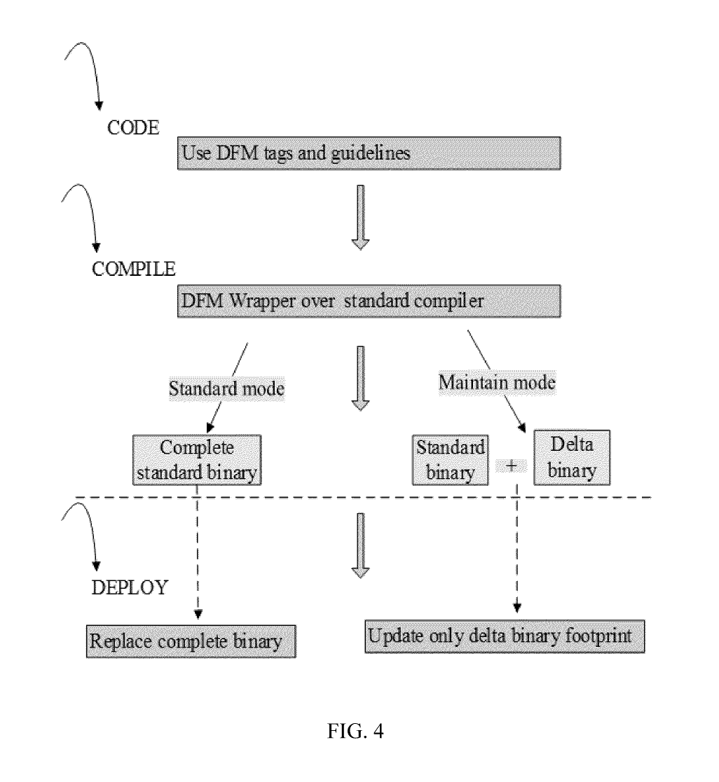

Referring now to FIG. 4, a compilation, generation of binary files and updating the same are shown, in accordance with an embodiment of the present application. In one implementation, the developer may need to use the DFM tags either while originally writing the code, to segregate features from the base, or while adding a new feature(s) to an existing code base which did not follow DFM tags in the first place. The developer should also adhere to the guidelines as listed in the previous section about matching the tags and managing the overlay features. The code may then be submitted for compilation using the flags suggesting the segregation of overlay features or to generate a default binary. According to the proposed invention, the syntax below may be used for the flags to be submitted to the DFM:

To generate a base binary executable and add-on binaries for features f₁ to fₙ:

Use flag −dfm_overlay f₁ f₂ . . . fₙ.

To generate one single binary executable:

Omit flag −dfm_overlay.

The compilation, generation of binaries and update of the same run time is represented in FIG. 4 and the working is described below.

Explained below is the DFM segregator and how the feature info will be extracted from the code.

In one implementation, an add-on code segregator which segregates the code base according to the feature tags provided for compilation using the arguments to −dfm_overlay flag. The following method will be applied by the segregator.
Create a base code set stripping out all the code between any of the DFM tags including the tags.
Parse the original copy of code to search for legality of tag usage and any nesting of tags; if an illegal usage or illegal nesting of tags found, return error back to the user and stop any further parsing.
Create a hierarchy tree of nested tags, with all unrelated tags at the topmost level and all children and/or siblings as the next level nodes in the hierarchy tree, subsequently.
Create code sets with code added from each node of the tree applied traversing breadth first, on top of the base code set created in step 1, and subsequently overlaid on top of each previous level code set created. This can be managed by assigning independent workspaces to each node of the tree while creating these sets and set of code files with appropriate changes can be managed within the workspace.
In parallel to step above submit each node code set for compilation to the standard compiler. The compilation can happen in parallel for each set, because logically it is a segregated code. In case any of the compilation steps returns error, return the same back to user and stop any further steps.

The above mentioned algorithm may be probably the simplest to achieve a segregation of code level features, and many optimizations can simply be inferred by intuition, for example possibility of merging multiple features at the same level in the hierarchy tree into a single feature set.

Explained below is the creation of differential binaries and layout of generated binaries with reference to the implementation disclosed above.

The DFM knows about the tags and the code submitted to it. It may be equipped with a very simple parser, which may be part of the segregator. The segregator may use this parser to segregate the code and generate differential code sets, according to the algorithm listed in the previous embodiment. The code sets as created, may be submitted to the standard compiler for compilation, in different workspaces. On successful compilation of all sets, a total of n+1 binaries, where n is the number of different feature tags encountered, may be generated in equal number of workspaces. Apart from submission of code sets to compiler, the segregator may also generate a feature change tables. These tables may store the change strings per feature. These will store the information about the functions, global variables and structures, common macros, inline functions and static variables, changed or newly introduced per feature compared to that features base set. One table may correspond to the difference between the features added on top to the corresponding base code set.

The DFM may follow the below method to generate the differential binaries, this method uses ELF file format as the reference, but need not be limited to this format alone.

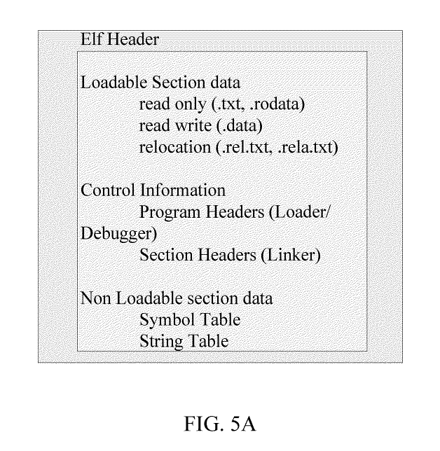

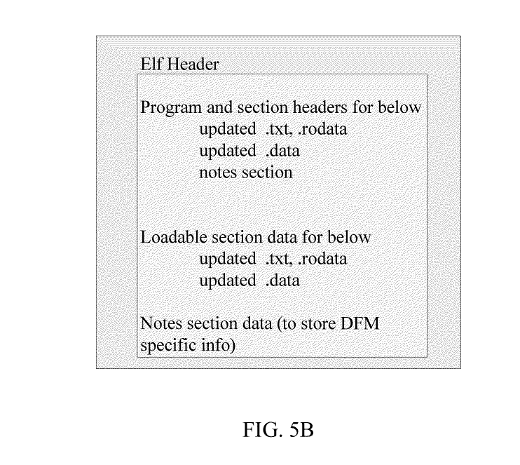

Considering Bb as the base generated binary; [Bb+f1] as the binary generated using base code set together with feature 1 code; [Bb+f1+f2] as the binary generated using base code set together with feature 1 code and feature 2 code and so on.
1. B_{b} is the base binary, which will be used as is.
2. For feature 1, look up the table T₁ (list of changes between base set and code set with base and feature1).
   Open a new binary file for writing (diff binary object—B_{f1}); store the elf header structure, with DFM information.
For each change entry in T₁ list:
   a. Search for the corresponding generated object code in the binary elf The sections which need to be looked up would correspond to text and data.
   b. If the change listing is for a function, store a program header structure for this text in the new diff binary object B_{f1}. Extract the complete footprint of the updated function from the text section of [B_{b}+f₁] and store it in the section corresponding to this program header.
c. If the change listing is for a global structure or a global variable, all the functions referencing the same have to be stored in B_{f1} following the above step. An additional program header and the corresponding section need to be added for the updated data. A single data section can store all the changes in the global data. The example format, in terms of the elf file, for the differential binary is shown in FIG. 5A.
d. If the change listing is for a macro or an inline function, all the functions referencing the same have to be stored in B_{f1} following the second step.
3. The differential binaries for subsequent features feature2, feature3 and so on; Bf2, Bf3, . . . and so on can be generated following the steps same as stated for feature 1.

It is understood by the person skilled in the art that, the outward symbol references in the new function footprint, both for data and called functions need to be addressed from the base binary file created. Thus storage of sections in Bf1, for example and all subsequent differential binaries should address this. Also the relocation entries and fix-ups need to be addressed, while loading the same in memory. To elaborate using the ELF file example, all code relocations are identified in the elf sections .rel.txt and .rela.txt of the base binary. The outward symbol references in the new function footprint should be updated with correct addresses before storing the same into the differential binary. Also if the symbol is one from dynamically loaded shared object, the fix-up address would be the corresponding entry in the procedure linkage table (PLT) of the base binary and should be correctly updated in the new function footprint.

The updates for data section pertaining to global variables and structures are more complicated, especially because a type is associated with each and partial updates could be made in the structures. The updates however are achievable, and the example of implementation with elf format is not explained, for the sake of simplicity.

It is understood that the examples provided above are implementation specific, and are provided for clarity of the proposed invention. Further, it is to be noted that the proposed invention does not introduce any change in the existing compiler, and the flags, submitted to the DFM are solely used by the DFM.

Referring now to FIG. 5A, FIG. 5A illustrates standard ELF file contents, in accordance with an embodiment of the present application.

FIG. 5B illustrates an exemplary differential binary contest, in accordance with an embodiment of the present application.

Although implementations for creating executable binary files with reduced overheads, less up gradation time for the existing binary files have been described in language specific to structural features and/or methods, it is to be understood that the appended claims are not necessarily limited to the specific features or methods described. Rather, the specific features and methods are disclosed as examples of implementations for creating executable binary files with reduced overheads, less up gradation time for the existing binary files.

In one example, the stored difference between each of the binaries, using the feature change tables 216 is extracted and stored in a new file, following some elf file format and nomenclature. This is the differential binary file and will be used as is as executable differential binary file 220.

Exemplary embodiments discussed above may provide certain advantages. Though not required to practice aspects of the disclosure, these advantages may include the following.
1. The proposed invention provides a mechanism of dynamic binary feature updates and segregation of features in the form of target binary objects of those imperative and to some extent the object oriented languages, which do not have this kind of facility already.
2. The proposed invention will be of use to write and maintain code using these languages and will no doubt be helpful especially for legacy code of such languages.
3. The proposed invention provides the add-on features that can be versioned and run time replacement of the feature with a newer version.
4. The proposed invention discloses a parser that can parse the computer program code and understand the feature tags.
5. The proposed invention provides the dynamic load and unloads of differential features on demand.

Finally, it should be understood that the above embodiments are only used to explain, but not to limit the technical solution of the present application. Despite the detailed description of the present application with reference to above preferred embodiments, it should be understood that various modifications, changes or equivalent replacements can be made by those skilled in the art without departing from the scope of the present application and covered in the claims of the present application.

What is claimed is:

1. A computer system having a non-transitory computer-readable medium including computer program logic encoded thereon that, when executed on the computer system provides a mechanism for creating and managing one or more executable differential binary files, that causes the computer system to perform operations of:
parsing at least one computer program source code having at least one dynamic feature manager (DFM) tag;
creating a plurality of code sets based on the DFM tags, wherein the code sets comprise a first code set having a base code and at least one second code set having the base code and a feature, wherein the base code is the at least one computer program source code without any DFM tag, and wherein the feature is a set of code;
generating one or more feature change tables, wherein the feature change tables store the information about a changed feature compared to the feature from the code sets;
stripping the DFM tag from the computer program source code to produce the base code, wherein the DFM tag is used to indicate that the feature is enclosed from the at least one computer program source code;
compiling the code sets for generating a plurality of binaries;
determining a difference between any two of the binaries using the feature change tables; and
creating a differential binary file(s) of the one or more executable differential binary files based on the difference determined.

2. The computer system according to claim 1, wherein the DFM tag follows syntax as DFM_<feature name>_start and DFM_<the feature name>_end to enclose the feature.

3. The computer system according to claim 1, wherein the DFM tag is added while writing the computer program source code.

4. The computer system according to claim 1, wherein the DFM tag is added while adding or updating new code to the computer program source code.

5. The computer system according to claim 1, wherein the feature is selected from a group comprising a function, a global variables and structures, a common macros, an inline function, a static variable, and a combination thereof.

6. The computer system according to claim 1, wherein in parsing the at least one computer program source code having the at least one DFM tag, the computer system is further caused to perform an operation of parsing at least one computer program source code having at least one DFM tag, to check for a nesting of the DFM tag and to create a hierarchy tree of the computer program source code, wherein the hierarchy tree comprises a DFM unrelated tag arranged at a topmost level, and a child and/or sibling tag as the next level node in the hierarchy tree.

7. The computer system according to claim 1, wherein the changed feature is selected from a group comprising functions, global variables, structures, common macros, inline functions, static variables, and/or a combination thereof, that is changed, newly introduced, or updated per feature as compared to the feature from the code sets.

8. The computer system according to claim 1, wherein the DFM tag follows a rule wherein a corresponding ‘end’ DFM tag is matched with a ‘start’ DFM tag of each feature.

9. The computer system according to claim 1, wherein the computer system is further caused to perform an operation of loading the differential binary file(s) to a memory and mapping the differential binary file(s) to executing binary.

10. A method for creating and managing at least one executable differential binary file, the method comprising:
parsing at least one computer program source code having at least one dynamic feature manager (DFM) tag;
creating a plurality of code sets based on the DFM tags, wherein the code sets comprise a first code set having the base code and at least one second code set having the base code and a feature, wherein the base code is the at least one computer program source code without any DFM tag, and wherein the feature is a set of code;
generating one or more feature change tables, wherein the feature change tables store the information about a changed feature compared to the feature from the code sets;
stripping the DFM tag from the computer program source code to produce a base code, wherein the DFM tag is used to indicate that the feature is enclosed from the at least one computer program source code;
compiling the code sets for generating a plurality of binaries;
determining a difference between any two of the binaries using the feature change tables; and
creating a differential binary file(s) of the one or more executable differential binary files based on the difference determined.

11. The method according to claim 10, wherein the DFM tag follows syntax as DFM_<the feature name>_start and DFM_<the feature name>_end to enclose the feature.

12. The method according to claim 10, wherein the DFM tag is added while writing the computer program source code.

13. The method according to claim 10, wherein the DFM tag is added while adding or updating new code to the computer program source code.

14. The method according to claim 10, wherein the feature is selected from a group comprising a function, a global variables and structures, a common macros, an inline function, a static variable, and a combination thereof.

15. The method according to claim 10, wherein parsing the at least one computer program source code having the at least one DFM tag comprises parsing at least one computer program source code having at least one DFM tag to check for a nesting of the DFM tag and to create a hierarchy tree of the computer program source code, wherein the hierarchy tree comprises a DFM unrelated tag arranged at a topmost level, and a child and/or sibling tag as the next level node in the hierarchy tree.

16. The method according to claim 11, wherein the changed feature is selected from a group comprising functions, global variables, structures, common macros, inline functions, static variables, and/or a combination thereof, that is changed, newly introduced, or updated per feature as compared to the feature from the code sets.

17. The method according to claim 10, wherein the DFM tag follows a rule wherein a corresponding ‘end’ DFM tag is matched with a ‘start’ DFM tag of each feature.

18. The method according to claim 10, wherein the computer system is further caused to perform an operation of loading the differential binary file(s) to a memory and mapping the differential binary file(s) to executing binary.
